(19) United States
(12) Patent Application Publication
(10) Pub. No.: US 2026/0054942 A1
(43) Pub. Date: Feb. 26, 2026

(54) BUFFER WALL SYSTEMS WITH MULTIPLE CONVEYOR SHELVES AND ASSOCIATED METHODS OF USE

(71) Applicant: Amazon Technologies, Inc., Seattle, WA (US)

(72) Inventors: Carl Nicklos, Washougal, WA (US); Bruce Johnson, La Center, WA (US); Alexander M Frenkel, Seattle, WA (US)

(21) Appl. No.: 18/812,636

(22) Filed: Aug. 22, 2024

(51) Int. Cl. B65G 47/90; B65G 21/12; B65G 47/52

(52) U.S. Cl. CPC B65G 47/901; B65G 21/12; B65G 47/52; B65G 2812/011

(57) ABSTRACT

Buffer wall systems and methods may comprise a plurality of shelves with associated buffer conveyors, and a gantry system with one or more powered conveyors. The gantry system may align the powered conveyors with individual buffer conveyors for item storage or retrieval. In addition, power transmission mechanisms of the powered conveyors may be actuated to engage and provide power to the buffer conveyors in order to cause transfer of items therebetween.

### BACKGROUND

Many companies may receive, store, package, and ship items and/or groups of items from material handling facilities. For example, many companies may receive and store items in a material handling facility and then package and ship items to various destinations (e.g., customers, stores) from the material handling facility. Various aspects of receiving, sorting, and storing processes may require significant space, cost, and time. Accordingly, there is a need for automated systems and methods to facilitate efficient receiving, sorting, and storing processes, while also reducing the required space, cost, and time associated with such processes.

### BRIEF DESCRIPTION OF THE DRAWINGS

FIG. 1 is a schematic diagram of an example item receipt, sortation, retrieval, and storage processes, in accordance with implementations of the present disclosure.

FIG. 2A is a schematic, perspective view diagram of an example buffer wall system with multiple buffer conveyors, in accordance with implementations of the present disclosure.

FIG. 2B is a schematic, perspective view diagram of a portion of an example buffer conveyor of a buffer wall system, in accordance with implementations of the present disclosure.

FIG. 2C is a schematic, perspective view diagram of a portion of an example sidewall of a buffer wall system, in accordance with implementations of the present disclosure.

FIG. 3 is a schematic, perspective view diagram of an example gantry conveyor and buffer conveyor of a buffer wall system, in accordance with implementations of the present disclosure.

FIG. 4 is a schematic, side view diagram of portions of an example gantry conveyor and buffer conveyor of a buffer wall system, in accordance with implementations of the present disclosure.

FIG. 5A is a schematic, side view diagram of portions of an example gantry conveyor and buffer conveyor of a buffer wall system in disengaged positions for item infeed, in accordance with implementations of the present disclosure.

FIG. 5B is a schematic, side view diagram of portions of an example gantry conveyor and buffer conveyor of a buffer wall system in engaged positions for item infeed, in accordance with implementations of the present disclosure.

FIG. 6A is a schematic, side view diagram of portions of an example gantry conveyor and buffer conveyor of a buffer wall system in disengaged positions for item outfeed, in accordance with implementations of the present disclosure.

FIG. 6B is a schematic, side view diagram of portions of an example gantry conveyor and buffer conveyor of a buffer wall system in engaged positions for item outfeed, in accordance with implementations of the present disclosure.

FIG. 7 is a flow diagram illustrating an example store item to buffer wall process, in accordance with implementations of the present disclosure.

FIG. 8 is a flow diagram illustrating an example retrieve item from buffer wall process, in accordance with implementations of the present disclosure.

FIG. 9 is a flow diagram illustrating an example item transfer to/from buffer wall process, in accordance with implementations of the present disclosure.

FIG. 10 is a flow diagram illustrating an example combined item to buffer wall storage/retrieval process, in accordance with implementations of the present disclosure.

FIG. 11 is a flow diagram illustrating an example buffer conveyor replacement process, in accordance with implementations of the present disclosure.

FIG. 12 is a block diagram illustrating various components of an example control system, in accordance with implementations of the present disclosure.

### DETAILED DESCRIPTION

As is set forth in greater detail below, implementations of the present disclosure are directed to automated buffer wall systems and associated methods to facilitate efficient and reliable receiving, sorting, and storing processes, e.g., for various types of items within a material handling facility.

In example embodiments, the automated buffer wall systems and methods may comprise a buffer wall having a frame and a plurality of buffer conveyors. The plurality of buffer conveyors may divide an overall, interior volume of the frame into a plurality of shelves or cubbies, and each shelf or cubby may be configured to receive and temporarily store one or more items. The buffer wall may also comprise a gantry system with one or more gantry or powered conveyors, in which the gantry system is configured to align the gantry conveyors with individual buffer conveyors to enable transfer of items. In some example embodiments, the gantry system may comprise two gantry or powered conveyors, e.g., a first gantry infeed conveyor configured to transfer items into individual buffer conveyors, and a second gantry outfeed conveyor configured to transfer items out of individual buffer conveyors.

In some example embodiments, the buffer conveyors may comprise passive conveyor units that do not include any actuators, motors, sensors, or electrical connections. The gantry or powered conveyors may comprise drive motors, shafts, rollers, or other components to drive respective conveyor belts of the gantry conveyors. In addition, the gantry or powered conveyors may include drive gears that are rotated by the drive motors, and power transmission mechanisms having transfer gears that can selectively engage and disengage with buffer gears and buffer shafts of individual buffer conveyors, in order to drive respective conveyor belts of the buffer conveyors. The gantry or powered conveyors may generally drive the buffer conveyors in a same direction, e.g., either an infeed direction or an outfeed direction, to transfer items therebetween. Further, the power transmission mechanisms may comprise various additional components to selectively engage and disengage drive gears and transfer gears relative to buffer gears of individual buffer conveyors, e.g., servo motors, servo arms, pushrods, swing arms, and/or other components.

In alternative example embodiments, the buffer conveyors may comprise active conveyor units including actuators, motors, sensors, and/or electrical connections. In such examples, the actuators or motors of the buffer conveyors may be instructed to actuate and transfer items between one or more gantry conveyors and individual buffer conveyors. However, active buffer conveyors may be associated with more components, increased size and weight, increased cost and power consumption, more complex control processes, and additional reliability, serviceability, and/or manufacturability issues.

In additional example embodiments, individual buffer conveyors may comprise modular, replaceable conveyor units that can be quickly and easily installed, deployed, removed, serviced, and/or replaced. For example, sides of the buffer conveyors may comprise pull tabs or strips with one or more friction fit or engagement features, and sidewalls of the frame may comprise tracks with friction fit or engagement surfaces, depressions, or features. Corresponding friction fit features of the buffer conveyors and frame sidewalls may engage with each other upon deployment or assembly, and such friction fit features may disengage from each other upon removal or disassembly. In this manner, a plurality of buffer conveyors may be quickly and easily deployed or assembled to a frame of a buffer wall, and removal, service, or replacement of individual buffer conveyors may also be quickly and easily performed.

Using the automated buffer wall systems and methods described herein, items may be received, sorted, and temporarily stored to individual shelves or cubbies of a buffer wall using gantry conveyors of a gantry system and buffer conveyors associated with individual shelves or cubbies. In some examples, the automated buffer wall systems and methods may be used to sort and store items upon receipt into a material handling facility or a portion thereof. In other examples, the automated buffer wall systems and methods may be used for various other temporary storage and/or sortation processes, which may be followed by subsequent retrieval and sortation, storage, packing, transfer, shipping, or other processes.

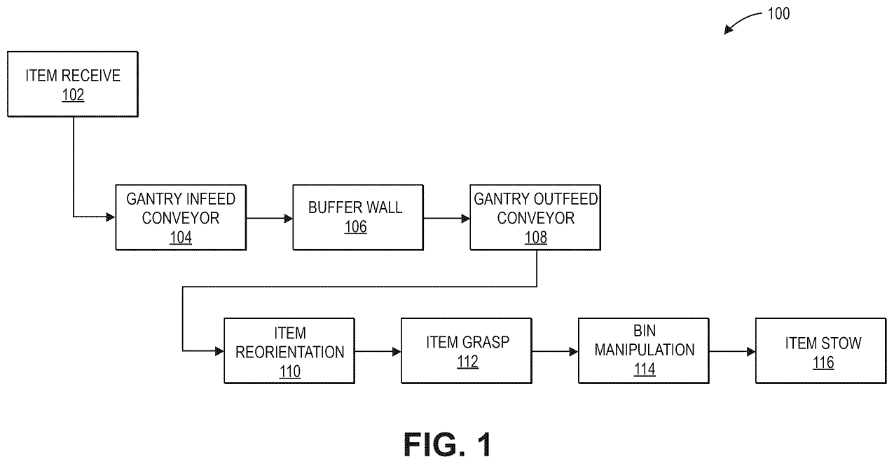

FIG. 1 is a schematic diagram 100 of an example item receipt, sortation, retrieval, and storage processes, in accordance with implementations of the present disclosure.

As shown in FIG. 1, example material handling processes may comprise item receive 102, transfer via a gantry infeed conveyor 104, temporary storage and/or sortation to a buffer wall 106, transfer via a gantry outfeed conveyor 108, item reorientation 110, item grasping 112, inventory holder bin manipulation 114, and/or item stow 116.

Item receive 102 may comprise receiving one or more items for temporary storage and sortation using a buffer wall. The items may be received from various systems or processes, including sources outside a material handling facility, other systems or processes within the facility, or others. The items may be singulated or separated into groupings or sets of items that are to be individually stored.

Then, the items may be transferred to a gantry infeed conveyor 104. For example, various automated vehicles, robotic arms and end effectors, conveyor systems, gantry systems, chutes, slides, or other material transfer systems may be used to transfer the items to a gantry infeed conveyor 104, which may be configured to temporarily sort and store items to a buffer wall 106. Individual shelves or cubbies of the buffer wall 106 may be configured to receive one or more items. In some examples, only a single item may be received by a single shelf or cubby at a time. In addition, an association between identifiers of the item and of the shelf or cubby may be stored in a database or memory. As further described herein, each individual shelf or cubby may have an associated buffer conveyor that is operated in cooperation with the gantry infeed conveyor 104 to transfer items to the buffer wall 106.

When items are to be removed from the buffer wall 106, a gantry outfeed conveyor 108 may be configured to retrieve the items from the buffer wall 106. Based on the stored associations between items and shelves or cubbies in which the items are stored, a particular shelf or cubby that is storing the item to be retrieved may be identified. Then, the gantry outfeed conveyor 108 may operate in cooperation with a buffer conveyor of the shelf or cubby to transfer items out of the buffer wall 106 and onto the gantry outfeed conveyor 108.

Upon retrieving the items from the buffer wall 106, item reorientation 110 may reposition and/or reorient the items for grasping and storage, e.g., to a bin of an inventory holder. For example, in order for a robotic arm and end effector to efficiently and quickly grasp an item, item reorientation 110 may turn, rotate, translate, or otherwise move the item to facilitate grasping. In one example, the item reorientation 110 may comprise a compliant, item rotation device having an item contact surface that at least partially compresses and turns, rotates, or slides the item to a desired position and/or orientation, e.g., on a surface of the gantry outfeed conveyor 108, or a different surface to which the item has been transferred from the gantry outfeed conveyor 108.

Then, item grasping 112 may comprise grasping and movement of the item for storage, e.g., to a bin of an inventory holder. For example, item grasping 112 may comprise a robotic arm and associated end effector that is configured to grasp, pick up, and transfer the item to a storage location. The storage location may comprise a particular bin of an inventory holder having a plurality of bins, and the inventory holder may be stationary or movable by an automated vehicle, robot, or associate within a material handling facility. In some examples, multiple items of the same or different types may be stored in individual bins of the inventory holder. Further, a storage location for an item, e.g., a particular bin of an inventory holder, may be selected based on various factors, such as item type, item dimensions, item weight, item destination, bin location, bin dimensions, bin weight capacity, available space or volume in a bin, one or more other items previously associated with the bin, other items to be stowed together with the item, destinations of other items, and/or various other factors.

In some example embodiments, inventory holder bin manipulation 114 may also be performed, which may comprise opening access doors or covers of a bin, moving elastic or flexible retention bands or strips over a bin, moving or adjusting positions or orientations of other items within a bin, and/or other manipulation tasks. The inventory holder bin manipulation 114 may be performed by another robotic arm and end effector, or other robotic or automated devices. In some examples, the inventory holder bin manipulation 114 may be at least partially performed by the robotic arm that has also performed item grasping 112, e.g., before or as part of item stow 116.

Item stow 116 may comprise transferring and storing the item within a bin of the inventory holder by the robotic arm and end effector that performed item grasping 112. The robotic arm may position the item within the bin, and release the item inside the bin to complete item stow 116. In this manner, items may be processed in a material handling facility from item receive 102 to item stow 116, which processing may utilize a buffer wall 106 and one or more gantry conveyors 104, 108 to facilitate sortation and storage of the items.

In additional example embodiments, various sensors may be associated with portions of the example material handling processes described herein with respect to FIG. 1. For example, one or more sensors may detect or identify items, confirm item transfer or receipt, detect items stored at storage locations, confirm retrieval of items, verify reorientation, grasping, and/or stow, and/or detect, confirm or verify various other aspects of the example material handling processes.

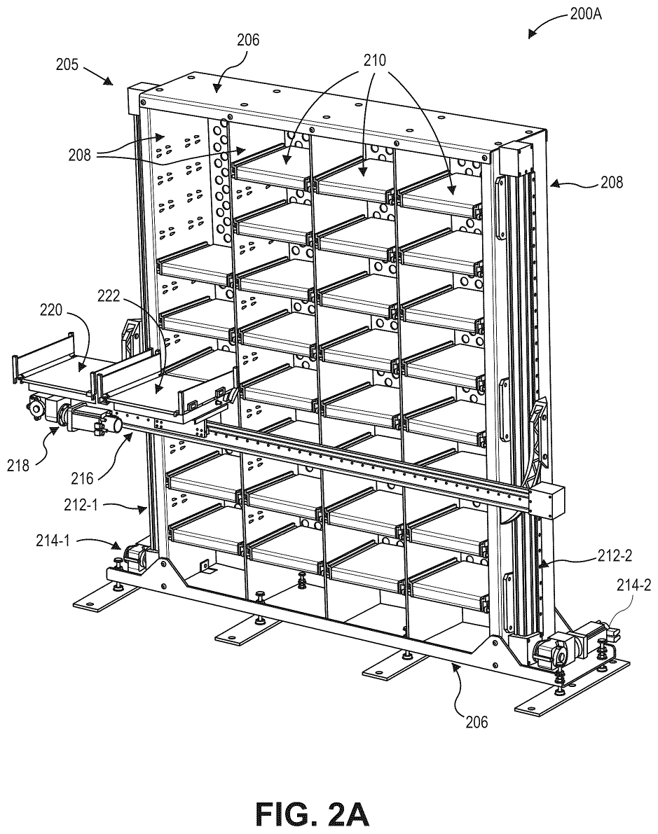

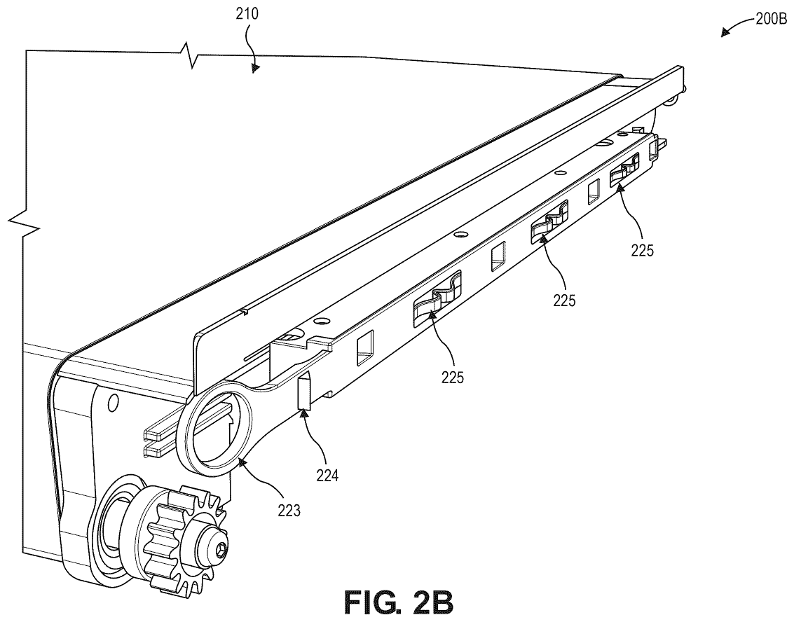

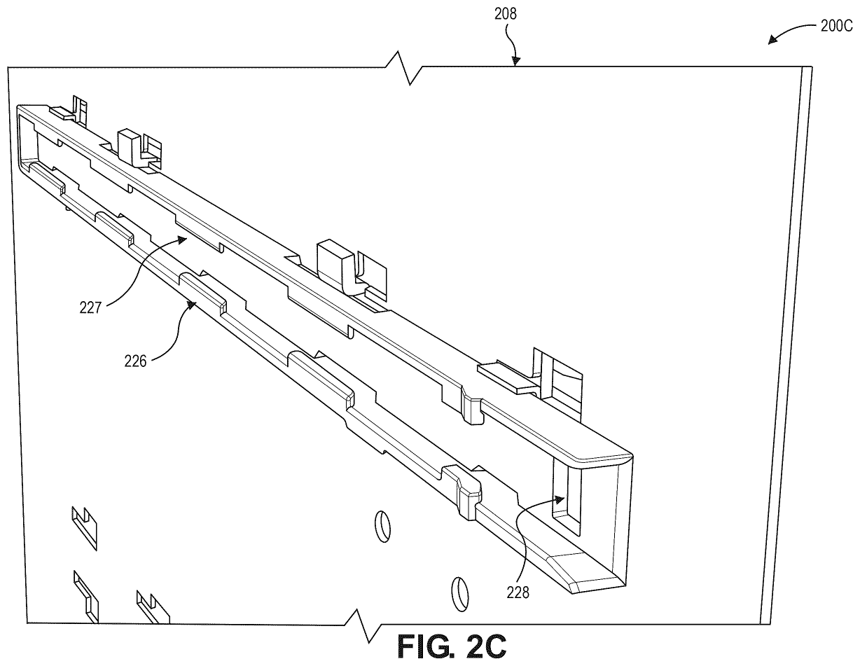

FIG. 2A is a schematic, perspective view diagram 200A of an example buffer wall system with multiple buffer conveyors, in accordance with implementations of the present disclosure.

As shown in FIG. 2A, an example buffer wall 205 may comprise a frame having upper and lower frame portions 206, a plurality of vertical frame portions or sidewalls 208, and a plurality of buffer conveyors 210.

The upper and lower frame portions 206 may comprise flat, horizontal plates, beams, surfaces, or other structures to form upper and lower extents of the frame of the buffer wall 205. In addition, the lower frame portion 206 may be fastened, attached, or coupled to a ground or other surface within a material handling facility for stability and support.

The sidewalls 208 of the frame of the buffer wall 205 may comprise flat, vertical plates, beams, surfaces, or other structures that are coupled at opposite ends to the upper and lower frame portions 206. The sidewalls 208 may extend between the upper and lower frame portions 206, thereby dividing an interior volume of the frame into a plurality of vertical columns. In addition, the sidewalls 208 may comprise multiple attachment slots, holes, or other features at which buffer conveyors 210 may be positioned, attached, or coupled.

The plurality of buffer conveyors 210 may be positioned, attached, or coupled at various positions between adjacent sidewalls 208 of the frame of the buffer wall 205, thereby dividing the interior volume of the frame into a plurality of shelves or cubbies. In some examples, the plurality of shelves or cubbies may all have a same, equal size, while in other examples, the plurality of shelves or cubbies may include at least two or multiple different sizes. Further, in some examples, the interior volume of the frame of the buffer wall 205 may be divided into approximately thirty two, approximately forty eight, or other numbers of shelves or cubbies. Example attachments or couplings between the buffer conveyors 210 and sidewalls 208 of the buffer wall 205 are described herein at least with respect to FIGS. 2B and 2C.

The upper and lower frame portions 206, the sidewalls 208, and portions of the buffer conveyors 210 of the buffer wall 205 may be formed of various materials, e.g., metals, plastics, composites, other materials, or combinations thereof.

As further shown in FIG. 2A, the example buffer wall 205 may also comprise a gantry system having one or more vertical movement mechanisms 212 and associated actuators 214, and a horizontal movement mechanism 216 and associated actuator 218. The gantry system may be operatively coupled to portions of the frame, e.g., portions of the sidewalls 208 and/or portions of the upper and lower frame portions 206, in order to move within a vertical plane along a front face of the buffer wall 205.

The one or more vertical movement mechanisms 212 and the horizontal movement mechanism 216 may comprise belt drive mechanisms, chain drive mechanisms, rack and pinion mechanisms, screw drive mechanisms, and/or other types of linear drive mechanisms. In addition, the actuators 214, 218 may comprise various types of actuators, rotary motors, linear actuators, or other types of motors or actuators to drive the vertical and horizontal movement mechanisms 212, 216, respectively.

As shown in FIG. 2A, two vertical movement mechanisms 212-1, 212-2 and associated actuators 214-1, 214-2 may be attached or coupled to opposite sidewalls 208 of the frame, and also attached or coupled to opposite ends of the horizontal movement mechanism 216. Upon actuation of the two vertical movement mechanisms 212-1, 212-2, the horizontal movement mechanism 216 may be moved vertically along a front face of the frame of the buffer wall 205.

Further, a gantry infeed conveyor 220 and a gantry outfeed conveyor 222 may be coupled to the horizontal movement mechanism 216. Upon actuation of the horizontal movement mechanism 216, the gantry infeed conveyor 220 and the gantry outfeed conveyor 222 may be moved horizontally along a front face of the frame of the buffer wall 205. By selective actuation of the two vertical movement mechanisms 212-1, 212-2 and the horizontal movement mechanism 216, each of the gantry infeed conveyor 220 and the gantry outfeed conveyor 222 may be moved to selectively align with individual buffer conveyors 210 of the buffer wall 205.

Upon aligning one of the gantry conveyors 220, 222 with a buffer conveyor 210, one or more items may be transferred between the gantry conveyors 220, 222 and the buffer conveyor 210. For example, the gantry infeed conveyor 220 may engage with a buffer conveyor 210 and cause transfer of an item from the gantry infeed conveyor 220 into a shelf or cubby associated with the buffer conveyor 210, e.g., an item storage process. Similarly, the gantry outfeed conveyor 222 may engage with a buffer conveyor 210 and cause transfer of an item from a shelf or cubby associated with the buffer conveyor 210 onto the gantry outfeed conveyor 222, e.g., an item retrieval process.

During item storage and retrieval processes, identifiers associated with the items and with the shelves or cubbies may be stored in a database or memory. For example, an identifier associated with an item to be stored may be scanned or imaged, e.g., using imaging or scanning sensors. Then, based on movement of the gantry system, e.g., using encoders associated with the actuators, a particular shelf or cubby to which the item is stored may be determined, and an identifier of the shelf or cubby may be stored in association with the item identifier.

Subsequently, when the item is to be retrieved, the particular shelf or cubby in which the item is stored may be determined based on the stored associations of the item identifier and shelf or cubby identifier. The gantry system may be instructed to move to the identified shelf or cubby, e.g., using encoders associated with the actuators, and retrieve the item. In addition, the identifier of the retrieved item may be verified by additional scanning or imaging, e.g., using imaging or scanning sensors. Upon retrieval and removal of the item from the shelf or cubby, the item identifier may be disassociated from the shelf or cubby identifier in the database or memory.

In this manner, storage locations of items within the various shelves or cubbies of the buffer wall 205 may be positively known and stored throughout use and operation of the buffer wall 205, including storage and retrieval processes using the gantry system and gantry conveyors 220, 222.

In alternative example embodiments, the gantry system described herein may be replaced or substituted with one or more other movement systems. For example, the gantry or powered conveyors, e.g., a gantry infeed conveyor and/or gantry outfeed conveyor, may be associated with and moved by one or more robotic arms, such as six-axis robotic arms or other types of robotic arms.

FIG. 2B is a schematic, perspective view diagram 200B of a portion of an example buffer conveyor of a buffer wall system, in accordance with implementations of the present disclosure.

As shown in FIG. 2B, a portion of an example buffer conveyor 210 is illustrated, e.g., a right side of a buffer conveyor 210 that can be inserted or installed into a frame of a buffer wall. Although only a right side of the buffer conveyor 210 is shown, a left side of the buffer conveyor 210 may comprise a mirror image of the features shown in FIG. 2B.

The buffer conveyor 210 may comprise a modular, replaceable conveyor unit that can be quickly and easily deployed, removed, serviced, and/or replaced in a buffer wall. In order to enable simple installation, removal, and replacement, the buffer conveyor 210 may comprise a pull tab or strip 223, a friction engagement tab 224, and one or more friction fit or engagement features 225. The pull tab 223, friction engagement tab 224, and friction fit features 225 may be formed of various materials, including plastics, composites, other materials, or combinations thereof.

The pull tab or strip 223 may extend at least partially along a depth of the buffer conveyor 210, e.g., from a front face toward a rear face of the frame of the buffer wall. In addition, the pull tab or strip 223 may have a grasping ring, loop, hook, paddle, or other similar structure to enable grasping and pulling of the pull tab or strip 223.

The friction engagement tab 224 may comprise one or more protruding or upstanding edges, surfaces, or features configured to engage and hold the buffer conveyor 210 within a portion of the buffer wall. For example, the friction engagement tab 224 may comprise a solid, rigid protrusion that is configured to engage a hole or slot of a portion of the buffer wall.

Further, the friction fit features 225 may comprise additional protruding or upstanding edges, surfaces, or features configured to engage with a portion of the buffer wall. For example, the friction fit features 225 may comprise living hinges, curved or arcuately formed segments, compliant protruding sections, spring-loaded rollers or sliders, or other similar flexible, elastic, or resilient features that may contact and generate friction with a portion of the buffer wall.

FIG. 2C is a schematic, perspective view diagram 200C of a portion of an example sidewall of a buffer wall system, in accordance with implementations of the present disclosure.

As shown in FIG. 2C, a portion of an example sidewall 208 of a buffer wall is illustrated, e.g., a right side sidewall 208 to which a right side of a buffer conveyor 210 may be inserted or installed. Although only a right side sidewall 208 is shown, a left side sidewall 208 may comprise a mirror image of the features shown in FIG. 2C.

The sidewall 208 may comprise a track 226 that is attached or coupled to the sidewall 208, e.g., via fasteners, clips, hooks, slots, holes, or other attachment features. In order to enable simple installation, removal, and replacement of a buffer conveyor 210, the track 226 may comprise friction surfaces 227, and a friction engagement slot 228. The track 226, friction surfaces 227, and friction engagement slot 228 may be formed of various materials, including plastics, composites, other materials, or combinations thereof.

The track 226 may extend at least partially along a depth of the sidewall 208, e.g., from a front face toward a rear face of the frame of the buffer wall. In addition, the track 226 may include various edges, surfaces, or other features to guide a buffer conveyor, e.g., to guide a pull tab or strip 223 of the buffer conveyor, during insertion, installation, removal, and/or replacement.

The friction engagement slot 228 may comprise one or more slots, holes, depressions, or other edges, surfaces, or features configured to engage with the friction engagement tab 224 of the buffer conveyor 210, in order to retain the buffer conveyor 210 within a portion of the buffer wall. For example, the friction engagement slot 228 may comprise a rectangular slot, depression, or cutout that is sized and shaped to receive the solid, rigid protrusion of the friction engagement tab 224 of the buffer conveyor 210.

Further, the friction surfaces 227 may comprise one or more smooth, grooved, textured, or other types of surfaces that are configured to contact the friction fit features 225 of the buffer conveyor 210. For example, the friction surfaces 227 may comprise smooth or textured surfaces that generate friction upon contact by the friction fit features 225 of the buffer conveyor 210.

As described herein with respect to FIGS. 2B and 2C, the pull tabs 223 and tracks 226 having various friction fit or engagement features 224, 225, 227, 228 may enable manual or automated insertion or installation of buffer conveyors 210 between adjacent sidewalls 208 of a buffer wall. The generated friction and engagement may ensure that the buffer conveyors 210 are retained or held in the buffer wall and do not inadvertently slide or fall out of the buffer wall. In addition, the generated friction may not be so high as to prevent manual or automated removal of buffer conveyors 210 by applying a tension or pulling force on the pull tabs 223 to disengage and reduce the generated friction between the pull tabs 223 and tracks 226. As a result, the buffer conveyors 210 may be quickly and easily deployed, inserted, installed, removed, serviced, and/or replaced, while also being securely installed and retained during various operations of the buffer wall and buffer conveyors 210.

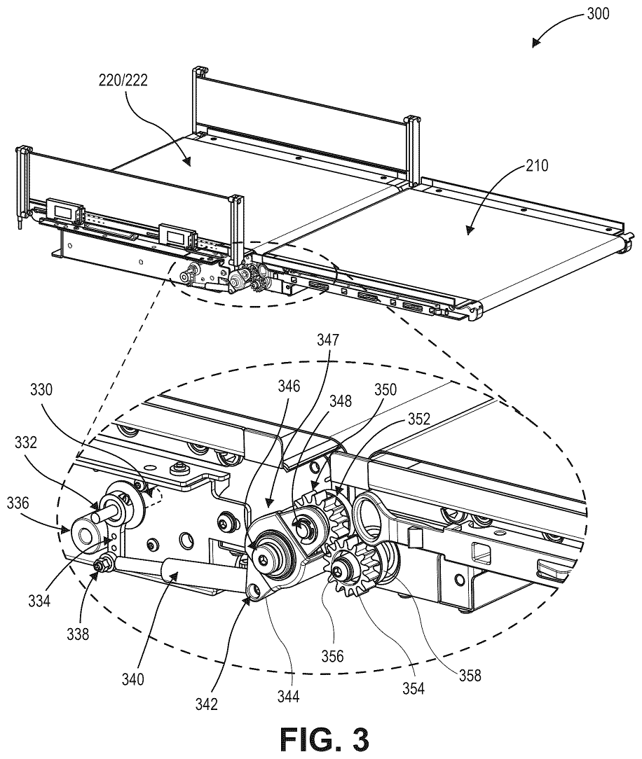

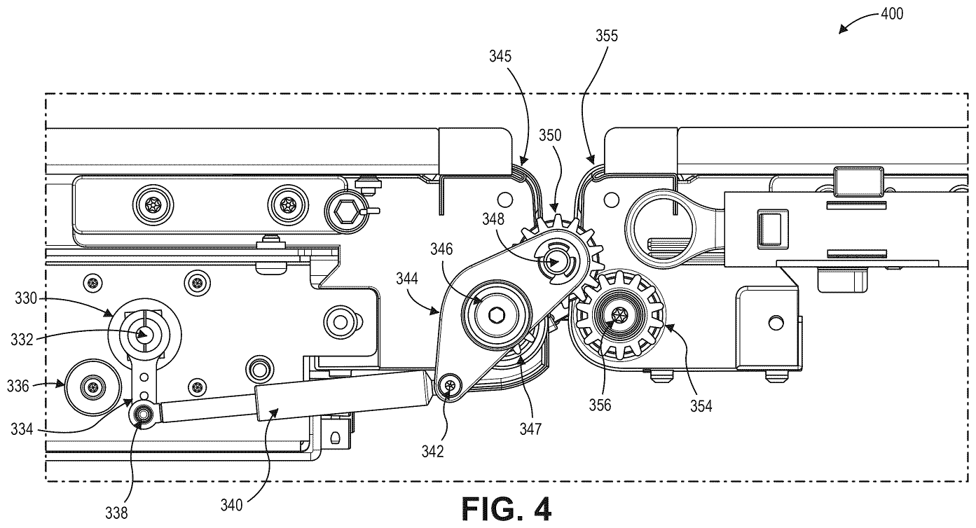

FIG. 3 is a schematic, perspective view diagram 300 of an example gantry conveyor and buffer conveyor of a buffer wall system, in accordance with implementations of the present disclosure, and FIG. 4 is a schematic, side view diagram 400 of portions of an example gantry conveyor and buffer conveyor of a buffer wall system, in accordance with implementations of the present disclosure.

As shown in FIGS. 3 and 4, an example gantry conveyor, e.g., a gantry infeed conveyor 220 or a gantry outfeed conveyor 222, may be positioned or aligned with a buffer conveyor 210 to transfer items therebetween. Although not illustrated for clarity, the gantry conveyor 220, 222 may be associated with a gantry system as shown in FIG. 2A, and the buffer conveyor 210 may be positioned or associated with a shelf or cubby of a buffer wall as shown in FIG. 2A.

The gantry conveyor 220, 222 may comprise a powered or active conveyor unit having a motor or actuator that is configured to drive a conveyor belt along a top surface of the gantry conveyor 220, 222. The motor or actuator may comprise various types of rotary motors, actuators, or others, and the motor or actuator may further comprise an encoder that detects rotation and/or rotational position of a drive shaft of the motor or actuator. The motor or actuator may cause rotation of the drive shaft, and the drive shaft may be operatively coupled to a portion of the conveyor belt in order to cause movement of the conveyor belt, either in an infeed direction toward the buffer conveyor 210 or in an outfeed direction away from the buffer conveyor 210. As further described herein, a drive gear may be coupled or associated with the drive shaft of the motor or actuator, which may be used to transfer power from the gantry conveyor 220, 222 to the buffer conveyor 210. Further, the buffer conveyor 210 may comprise an unpowered or passive conveyor unit having a passively driven conveyor belt, without any motors, actuators, sensors, or electrical connections.

As further shown in the close-up view at the bottom of FIG. 3, and also in FIG. 4, the gantry conveyor 220, 222 may comprise a power transmission mechanism that is configured to selectively engage or disengage with the buffer conveyor 210, in order to cause movement of the passively driven conveyor belt of the buffer conveyor 210, e.g., in a same direction as the direction of movement of the conveyor belt of the gantry conveyor 220, 222. The power transmission mechanism may comprise a servo motor 330, a servo arm 334, a mechanical stop 336, a spring-loaded pushrod 340, a swing arm 344, a drive gear 347, a transfer gear 350, and a buffer gear 354, and various connections and interfaces therebetween.

The servo motor 330 may comprise various types of servo motors or similar actuators, and may further comprise an encoder that detects rotation and/or rotational position of a servo shaft 332 of the servo motor 330. The servo motor 330 may cause rotation of the servo shaft 332 between at least two positions, and the servo arm 334 may be coupled or attached to the servo shaft 332. For example, the servo motor 330 may rotate the servo shaft 332 and servo arm 334 between a retracted position and an engaged position, as further described herein. In some examples, the mechanical stop 336 may prevent or limit movement of the servo arm 334 in at least one direction, e.g., to prevent overrotation of the servo arm 334 beyond at least one of the retracted position or the engaged position.

At an end of the servo arm 334 distal from the servo shaft 332, the servo arm 334 may be coupled to the spring-loaded pushrod 340 via a pivotal coupling 338. The pivotal coupling 338 may allow relative rotation of the servo arm 334 and the pushrod 340 around the pivotal coupling 338. The spring-loaded pushrod 340 may comprise a spring, shock absorber, gas strut, strut with a compressible foam or rubber member, damper, or other similar bias elements, and the pushrod 340 may apply a small bias force, preload, or tension that tends to shorten or reduce a length of the pushrod 340. As further described herein, this preload or tension may help overcome gear teeth collisions and facilitate proper engagement between teeth of the transfer gear 350 and the buffer gear 354, in order to transfer power to the buffer conveyor 210. In some alternative embodiments, the spring-loaded pushrod 340 may be replaced or substituted by other components or devices that can apply a similar preload or tension, such as a torque-limiting servo used as the servo motor 330, or various other types of springs, shock absorbers, dampers, or other bias elements.

At an end of the pushrod 340 distal from the servo arm 334, the pushrod 340 may be coupled to the swing arm 344 via a pivotal coupling 342. The pivotal coupling 342 may allow relative rotation of the pushrod 340 and the swing arm 344 around the pivotal coupling 342. In addition, the swing arm 344 may also be coupled to the drive shaft 346 of the motor of the gantry conveyor 220, 222 via a pivotal coupling, which may allow relative rotation of the swing arm 344 around the drive shaft 346. Further, the swing arm 344 may also comprise the transfer gear 350 that is rotatably coupled to the swing arm 344 via pivotal coupling 348, such that the transfer gear 350 can rotate around the pivotal coupling 348.

During rotation of the drive shaft 346, the drive gear 347 that is coupled to the drive shaft 346 rotates together with the drive shaft 346. In addition, the transfer gear 350 and its pivotal coupling 348 are positioned on the swing arm 344 so that the teeth of the drive gear 347 are always in engagement with the teeth of the transfer gear 350. Thus, the transfer gear 350 rotates together with rotation of the drive gear 347. Due to the pivotal coupling of the swing arm 344 to the drive shaft 346, however, the swing arm 344 does not rotate together with the drive shaft 346. Instead, the swing arm 344 may be moved between at least two positions, e.g., a retracted position and an engaged position, by the operation of the servo motor 330 that causes movement of the servo arm 334, the pushrod 340, and the swing arm 344 via respective couplings.

As shown in FIGS. 3 and 4, the servo arm 334, the pushrod 340, and the swing arm 344 may be positioned in respective engaged positions, such that teeth of the transfer gear 350 engage or mesh with teeth of the buffer gear 354 of the buffer conveyor 210. The buffer gear 354 may be coupled to a buffer shaft 356 in order to rotate together, and the buffer shaft 356 may be operatively coupled to a portion of a conveyor belt in order to cause movement of the conveyor belt, either in an infeed direction away from the gantry conveyor 220, 222 or in an outfeed direction toward the gantry conveyor 220, 222.

When the teeth of the transfer gear 350 are engaged or meshed with the teeth of the buffer gear 354, rotation of the drive shaft 346 by a drive motor or actuator of the gantry conveyor 220, 222 may cause rotation of the drive gear 347, corresponding rotation of the transfer gear 350, and further corresponding rotation of the buffer gear 354, thereby causing rotation of the buffer shaft 356 to passively drive the conveyor belt of the buffer conveyor 210.

In further example embodiments, the transfer gear 350 may comprise a cylindrical guide 352, and the buffer gear 354 may also comprise a cylindrical guide 358. The cylindrical guides 352, 358 may be integrally formed or assembled together with the transfer gear 350 and buffer gear 354, respectively. In addition, the cylindrical guides 352, 358 may be generally solid cylinders that are formed with outer diameters that are approximately equal to pitch diameters of the respective gears, and the cylindrical guides 352, 358 may be configured to contact and rotate relative to each other upon engagement between the transfer gear 350 and the buffer gear 354. By forming the cylindrical guides 352, 358 with outer diameters that correspond to pitch diameters of the respective gears, the engagement of the teeth of the transfer gear 350 and the buffer gear 354 may be controlled for substantially optimal tooth engagement and smooth, reliable operation, while preventing overengagement or too closely meshing that may lead to jamming, excessive forces, and wear and tear on the gears and their teeth.

Furthermore, the power transmission mechanism described herein may be a substantially self-engaging geartrain. For example, responsive to movements of the servo arm 334, the pushrod 340, and the swing arm 344 to respective engaged positions, the preload or tension associated with the pushrod 340 may tend to urge or bias the swing arm 344 and the transfer gear 350 toward engagement with the buffer gear 354. Moreover, reaction forces among the drive gear 347, the transfer gear 350, and the buffer gear 354 may tend to maintain the gears in engagement with each other. In this respect, the forces associated with causing rotation of the transfer gear 350 by rotation of the drive gear 347 may urge or bias the transfer gear 350 toward engagement with the buffer gear 354. Furthermore, the forces associated with causing rotation of the buffer gear 354 by rotation of the transfer gear 350 may further urge or bias the transfer gear 350 toward engagement with the buffer gear 354. Because of the self-engaging aspects of the power transmission mechanism, no additional locking or retention components may be needed to maintain the gears in engagement with each other.

In additional example embodiments, in order to disengage the transfer gear 350 from the buffer gear 354, e.g., following completion of transfer of items between the gantry conveyor 220, 222 and the buffer conveyor 210, the drive motor or actuator of the gantry conveyor 220, 222 may be instructed to rotate in an opposite rotational direction from the direction of rotation during transfer of items. Such rotation of the drive gear 347, the transfer gear 350, and the buffer gear 354 in opposite rotational directions may result in substantially automatic disengagement between the transfer gear 350 and the buffer gear 354. For example, reaction forces among the drive gear 347, the transfer gear 350, and the buffer gear 354 may tend to separate or move the transfer gear 350 and the buffer gear 354 out of engagement with each other. In this respect, the forces associated with causing opposite rotation of the transfer gear 350 by opposite rotation of the drive gear 347 may urge or bias the transfer gear 350 out of engagement with the buffer gear 354. Furthermore, the forces associated with causing opposite rotation of the buffer gear 354 by opposite rotation of the transfer gear 350 may further urge or bias the transfer gear 350 out of engagement with the buffer gear 354. Because of the auto-disengaging aspects of the power transmission mechanism, no additional release or separation components may be needed to move the gears out of engagement with each other.

Moreover, the power transmission mechanism described herein may be relatively tolerant to translational or linear misalignments between the gantry conveyor 220, 222 and the buffer conveyor 210, e.g., within approximately a few millimeters in various directions. For example, the power transmission mechanism may still function to transfer power in the presence of translational or linear misalignments in the orthogonal X, Y, or Z directions of a few millimeters. In this respect, misalignments in the X direction may correspond to how close or far the gantry conveyor 220, 222 and the buffer conveyor 210 are relative to each other along infeed or outfeed directions, misalignments in the Y direction may correspond to how far left or right the gantry conveyor 220, 222 and the buffer conveyor 210 are relative to each other along directions transverse and coplanar with infeed or outfeed directions, and misalignments in the Z direction may correspond to how far up or down the gantry conveyor 220, 222 and the buffer conveyor 210 are relative to each other along directions transverse and orthogonal with infeed or outfeed directions.

In some additional example embodiments, the power transmission mechanism described herein may also be relatively tolerant to rotational misalignments between the gantry conveyor 220, 222 and the buffer conveyor 210, e.g., within approximately a few degrees in various rotational directions. For example, the power transmission mechanism may still function to transfer power in the presence of rotational misalignments around orthogonal X, Y, or Z directions of a few degrees. In this respect, rotational misalignments around the X direction, e.g., the infeed or outfeed directions, may correspond to how level the right and left sides of the gantry conveyor 220, 222 and the buffer conveyor 210 are relative to each other, rotational misalignments around the Y direction, e.g., directions transverse and coplanar with infeed or outfeed directions, may correspond to how level the front and rear sides of the gantry conveyor 220, 222 and the buffer conveyor 210 are relative to each other, and rotational misalignments around the Z direction, e.g., directions transverse and orthogonal with infeed or outfeed directions, may correspond to how close or far the right and left sides of the gantry conveyor 220, 222 and the buffer conveyor 210 are relative to each other.

In further example embodiments, in order to provide additional tolerance to translational and/or rotational misalignments, the gears of the power transmission mechanism may be selected to have relatively coarse teeth, e.g., larger tooth pitch. In some examples, the drive gear 347, the transfer gear 350, and the buffer gear 354 may have approximately fourteen, sixteen, twenty, or other numbers of teeth, which may enable additional tolerance to various misalignments between the gantry conveyor 220, 222 and the buffer conveyor 210. In addition, because the power transmission mechanism may operate at relatively low speeds, gears having relatively coarse and fewer teeth may nonetheless operate reliably to transfer power from gantry conveyors to buffer conveyors.

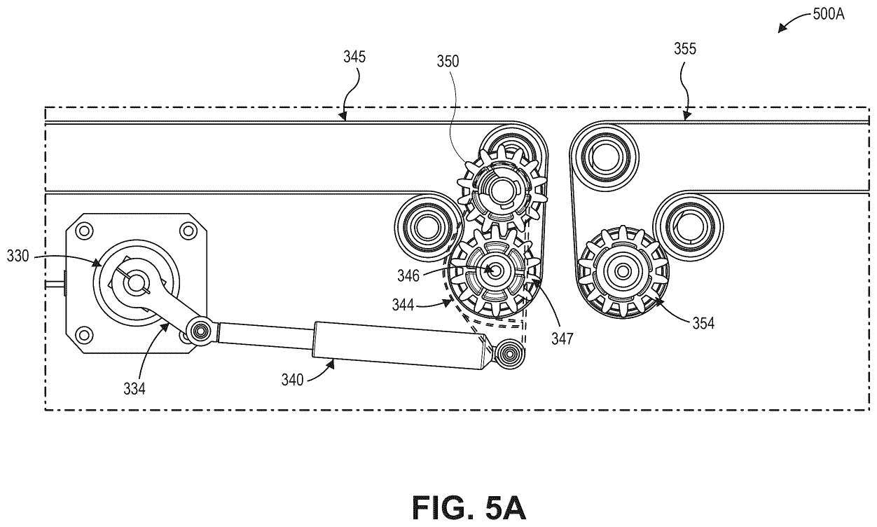

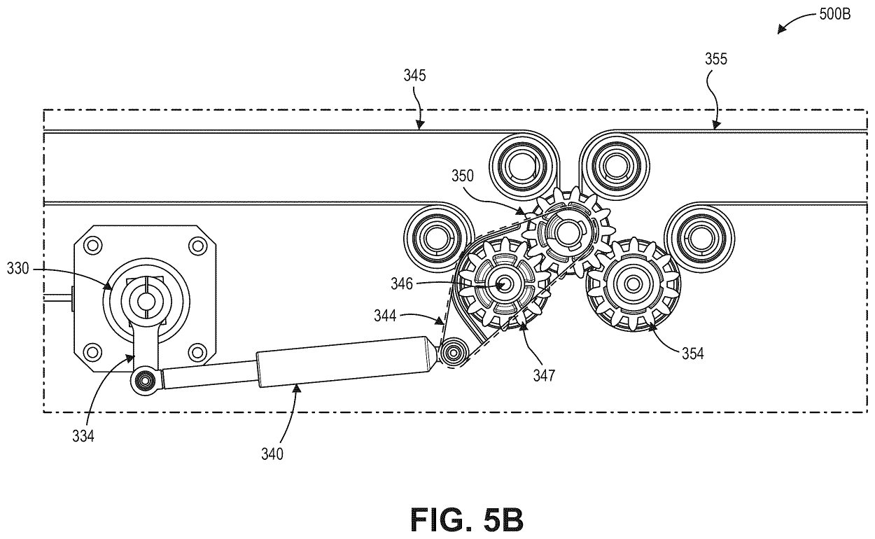

FIG. 5A is a schematic, side view diagram 500A of portions of an example gantry conveyor and buffer conveyor of a buffer wall system in disengaged positions for item infeed, in accordance with implementations of the present disclosure.

As shown in the disengaged or retracted position or configuration of FIG. 5A, the servo motor 330 may be rotated or actuated, e.g., in a counter-clockwise direction, to a retracted position. As a result, the servo arm 334 may also be rotated or moved, e.g., in a counter-clockwise direction, to a retracted position. In addition, movement of the servo arm 334 may cause corresponding movement of the pushrod 340 and the swing arm 344 to respective retracted positions.

In the retracted position of the swing arm 344, the swing arm 344 may be rotated in a counter-clockwise direction around the drive shaft 346 and drive gear 347. Because of the counter-clockwise rotation of the swing arm 344, the transfer gear 350 may be rotated away from engagement with the buffer gear 354. Thus, even if the drive shaft 346 is being rotated, e.g., in a clockwise direction, by the drive motor and thereby causing the conveyor belt 345 of the gantry conveyor to move in an infeed direction toward the buffer conveyor, the conveyor belt 355 of the buffer conveyor is not caused to move because the transfer gear 350 is not engaged with the buffer gear 354.

FIG. 5B is a schematic, side view diagram 500B of portions of an example gantry conveyor and buffer conveyor of a buffer wall system in engaged positions for item infeed, in accordance with implementations of the present disclosure.

As shown in the engaged position or configuration of FIG. 5B, the servo motor 330 may be rotated or actuated, e.g., in a clockwise direction relative to FIG. 5A, to an engaged position. As a result, the servo arm 334 may also be rotated or moved, e.g., in a clockwise direction, to an engaged position. In addition, movement of the servo arm 334 may cause corresponding movement of the pushrod 340 and the swing arm 344 to respective engaged positions.

In the engaged position of the swing arm 344, the swing arm 344 may be rotated in a clockwise direction around the drive shaft 346 and drive gear 347. Because of the clockwise rotation of the swing arm 344, the transfer gear 350 may be rotated toward engagement with the buffer gear 354. Thus, when the drive shaft 346 is being rotated, e.g., in a clockwise direction, by the drive motor and thereby causing the conveyor belt 345 of the gantry conveyor to move in an infeed direction toward the buffer conveyor, the conveyor belt 355 of the buffer conveyor is also caused to move in the infeed direction because of the engagement between the transfer gear 350 and the buffer gear 354.

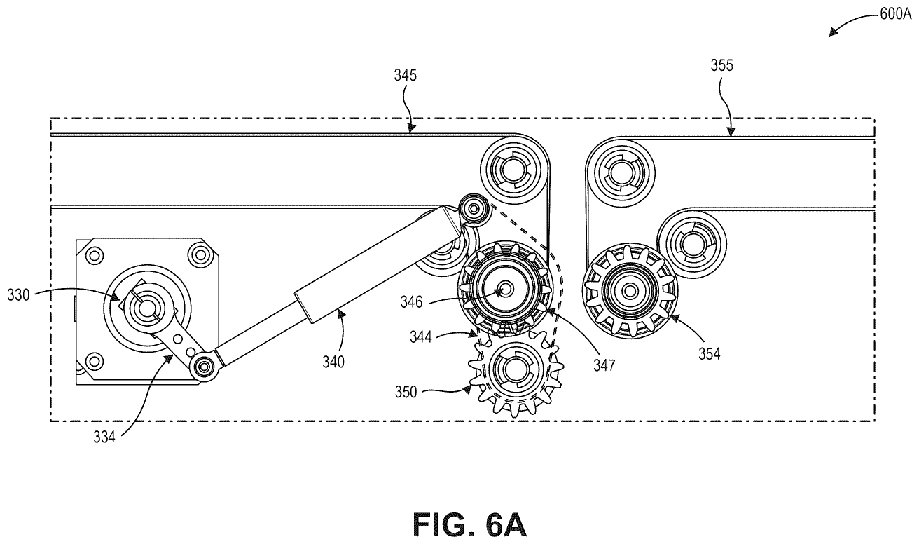

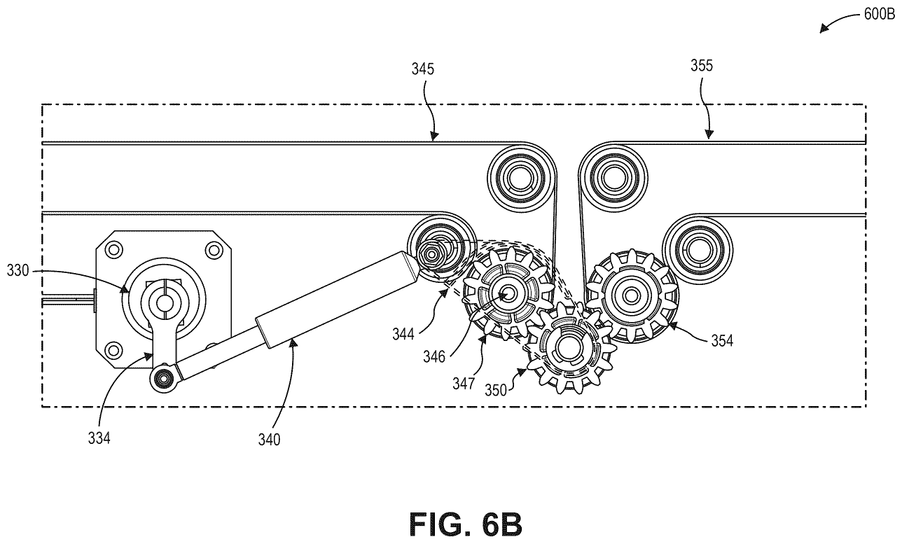

FIG. 6A is a schematic, side view diagram 600A of portions of an example gantry conveyor and buffer conveyor of a buffer wall system in disengaged positions for item outfeed, in accordance with implementations of the present disclosure.

As shown in the disengaged or retracted position or configuration of FIG. 6A, the servo motor 330 may be rotated or actuated, e.g., in a counter-clockwise direction, to a retracted position. As a result, the servo arm 334 may also be rotated or moved, e.g., in a counter-clockwise direction, to a retracted position. In addition, movement of the servo arm 334 may cause corresponding movement of the pushrod 340 and the swing arm 344 to respective retracted positions.

In the retracted position of the swing arm 344, the swing arm 344 may be rotated in a clockwise direction around the drive shaft 346 and drive gear 347. Because of the clockwise rotation of the swing arm 344, the transfer gear 350 may be rotated away from engagement with the buffer gear 354. Thus, even if the drive shaft 346 is being rotated, e.g., in a counter-clockwise direction, by the drive motor and thereby causing the conveyor belt 345 of the gantry conveyor to move in an outfeed direction away from the buffer conveyor, the conveyor belt 355 of the buffer conveyor is not caused to move because the transfer gear 350 is not engaged with the buffer gear 354.

FIG. 6B is a schematic, side view diagram 600B of portions of an example gantry conveyor and buffer conveyor of a buffer wall system in engaged positions for item outfeed, in accordance with implementations of the present disclosure.

As shown in the engaged position or configuration of FIG. 6B, the servo motor 330 may be rotated or actuated, e.g., in a clockwise direction relative to FIG. 6A, to an engaged position. As a result, the servo arm 334 may also be rotated or moved, e.g., in a clockwise direction, to an engaged position. In addition, movement of the servo arm 334 may cause corresponding movement of the pushrod 340 and the swing arm 344 to respective engaged positions.

In the engaged position of the swing arm 344, the swing arm 344 may be rotated in a counter-clockwise direction around the drive shaft 346 and drive gear 347. Because of the counter-clockwise rotation of the swing arm 344, the transfer gear 350 may be rotated toward engagement with the buffer gear 354. Thus, when the drive shaft 346 is being rotated, e.g., in a counter-clockwise direction, by the drive motor and thereby causing the conveyor belt 345 of the gantry conveyor to move in an outfeed direction away from the buffer conveyor, the conveyor belt 355 of the buffer conveyor is also caused to move in the outfeed direction because of the engagement between the transfer gear 350 and the buffer gear 354.

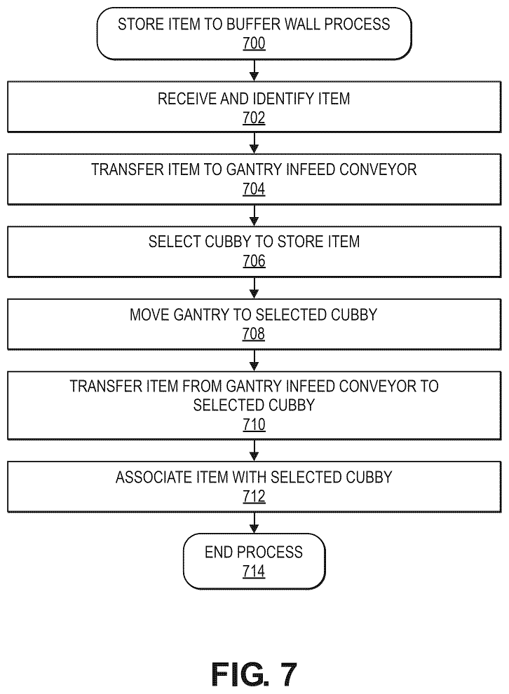

FIG. 7 is a flow diagram illustrating an example store item to buffer wall process 700, in accordance with implementations of the present disclosure.

The process 700 may begin by receiving and identifying an item, as at 702. For example, an item may be received from a source outside a material handling facility, or a different system or process within a material handling facility. In addition, the item may be identified using various methods, e.g., based on imaging data, by scanning identifiers associated with the item, by detecting radiofrequency identifiers, and/or other methods. Further, a control system may instruct receiving and identifying the item.

The process 700 may continue by transferring the item to a gantry infeed conveyor, as at 704. For example, the item may be moved or transferred to the gantry infeed conveyor via various methods, such as robotic or automated vehicles or shuttles, robotic arms and end effectors, conveyors, slides, chutes, and/or other methods. Then, the gantry infeed conveyor may receive the item on an upper surface of a conveyor belt thereof. Further, a control system may instruct transferring the item to the gantry infeed conveyor.

The process 700 may proceed by selecting a cubby to store the item, as at 706. For example, a particular shelf or cubby of a buffer wall may be selected for storage of the item. In some examples, an empty or unoccupied cubby may be selected, and in other examples, a partially occupied cubby with one or more similar items or items having a similar destination may be selected. Moreover, various other factors may be used to select a cubby for an item, such as item type, item dimensions, item weight, item destination, cubby location, cubby dimensions, cubby weight capacity, available space or volume in a cubby, one or more other items previously associated with the cubby, other items to be stored together with the cubby, destinations of other items, and/or various other factors. In addition, a location or position of the selected cubby within the buffer wall may be identified. Further, a control system may instruct selecting a cubby to store the item.

The process 700 may then continue to move the gantry to the selected cubby, as at 708. For example, the gantry system may comprise one or more vertical and/or horizontal movement mechanisms to cause movement of the gantry infeed conveyor to a desired position. In this manner, the gantry infeed conveyor may be positioned or aligned with the selected cubby, e.g., aligned to a front face of the cubby so that a conveyor belt of the gantry infeed conveyor is approximately coplanar with a conveyor belt of the selected cubby. Further, a control system may instruct moving the gantry to the selected cubby.

The process 700 may proceed to transfer the item from the gantry infeed conveyor to the selected cubby, as at 710. For example, the gantry infeed conveyor may actuate a conveyor belt to cause movement of the received item toward the selected cubby. In addition, a conveyor belt of the selected cubby, e.g., a buffer conveyor, may also be actuated to receive the item from the gantry infeed conveyor into the selected cubby. In some examples, the buffer conveyor may comprise an active conveyor unit that includes an actuator to cause movement of the conveyor belt, and in other examples, the buffer conveyor may comprise a passive conveyor unit that is actuated by the gantry infeed conveyor via a power transmission mechanism. Further, a control system may instruct transferring the item to the selected cubby.

The process 700 may continue with associating the item with the selected cubby, as at 712. For example, identifiers of the item and of the selected cubby may be associated with each other and stored in a database or memory. In this manner, a position of the stored item within the selected cubby of the buffer wall may be known and maintained, in order to facilitate later retrieval of the item for subsequent processing. Further, a control system may instruct associating the item with the selected cubby.

The process 700 may then end, as at 714. Furthermore, the various steps of FIG. 7 may be repeated to perform additional storage of items to a buffer wall.

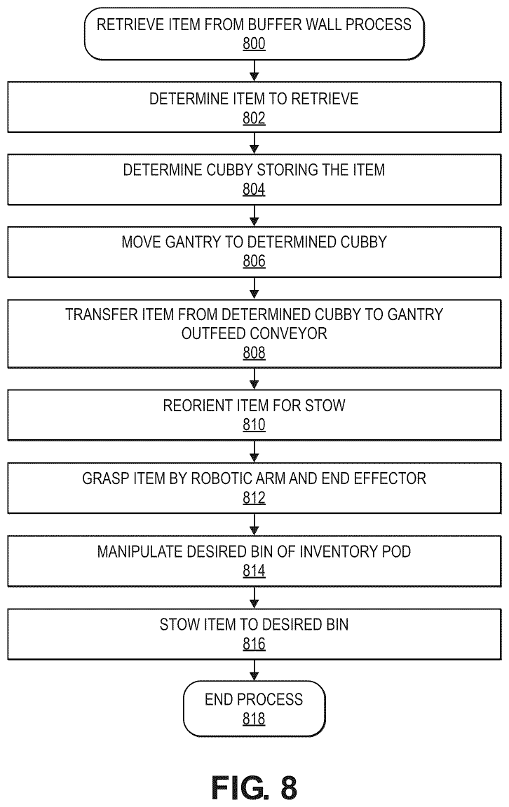

FIG. 8 is a flow diagram illustrating an example retrieve item from buffer wall process 800, in accordance with implementations of the present disclosure.

The process 800 may begin by determining an item to retrieve, as at 802. For example, it may be determined to retrieve an item that has previously been stored in a cubby of a buffer wall. For example, the item may be requested by a downstream system or process, e.g., for packaging and shipping to a destination. In addition, an identifier associated with the item may be determined. Further, a control system may instruct determining an item to retrieve.

The process 800 may continue by determining a cubby storing the item, as at 804. For example, based on a stored association between the identifier of the item and a cubby of the buffer wall, it may be determined that the item was previously stored in a particular shelf or cubby of the buffer wall. In addition, a location or position of the determined cubby within the buffer wall may be identified. Further, a control system may instruct determining a cubby storing the item.

The process 800 may proceed by moving the gantry to the determined cubby, as at 806. For example, the gantry system may comprise one or more vertical and/or horizontal movement mechanisms to cause movement of a gantry outfeed conveyor to a desired position. In this manner, the gantry outfeed conveyor may be positioned or aligned with the determined cubby, e.g., aligned to a front face of the cubby so that a conveyor belt of the gantry outfeed conveyor is approximately coplanar with a conveyor belt of the determined cubby. Further, a control system may instruct moving the gantry to the determined cubby.

The process 800 may continue to transfer the item from the determined cubby to the gantry outfeed conveyor, as at 808. For example, the gantry outfeed conveyor may actuate a conveyor belt to cause movement of the item out of the determined cubby. In addition, a conveyor belt of the selected cubby, e.g., a buffer conveyor, may also be actuated to transfer the item out of the determined cubby to the gantry outfeed conveyor. In some examples, the buffer conveyor may comprise an active conveyor unit that includes an actuator to cause movement of the conveyor belt, and in other examples, the buffer conveyor may comprise a passive conveyor unit that is actuated by the gantry outfeed conveyor via a power transmission mechanism. Moreover, upon transferring the item out of the determined cubby, identifiers of the item and the determined cubby may be disassociated from each other in a database or memory. In this manner, a removal of the item from the determined cubby of the buffer wall may be updated and confirmed, in order to maintain accurate data related to items stored within the buffer wall for subsequent processing. Further, a control system may instruct transferring the item to the gantry outfeed conveyor.

The process 800 may proceed to reorient the item for stow, as at 810. For example, a position or orientation of the item transferred onto the gantry outfeed conveyor may need to be modified to enable stowing of the item. In some examples, the item may be turned or rotated by a compliant, overhead device that applies a pressure to the item and rotates the item on a flat surface, e.g., the gantry outfeed conveyor or another surface. In addition, the item may also be moved or repositioned in order to facilitate stowing of the item. Further, a control system may instruct reorienting the item for stow.

The process 800 may continue with grasping the item by a robotic arm and end effector, as at 812. For example, the item may have been repositioned and/or reoriented in order to facilitate grasping by the robotic arm and end effector. The robotic arm may comprise any type of robotic arm, e.g., a six axis robotic arm, and the end effector may comprise various types of end effectors, e.g., pinching or grasping end effectors, scooping or sliding end effectors, vacuum or suction end effectors, or other types of end effectors. The robotic arm and end effector may grasp and/or manipulate the item in order to stow the item, e.g., to a bin of an inventory holder. Further, a control system may instruct grasping the item by the robotic arm and end effector.

The process 800 may proceed with manipulating a desired bin of an inventory pod, as at 814. For example, a desired bin to which the item is to be stowed may include a door, closure, lip, retention bands, or other features that may generally retain items stowed therein. One or more other robotic arms, end effectors, or other automated manipulators may be used to enable access to the desired bin. In some examples, an automated manipulator may open a door or closure, or push apart retention bands in order to enable stowing of the item therein, and in other examples, the robotic arm and end effector that has grasped the item may itself at least partially manipulate the desired bin for storing of the item. Further, a control system may instruct manipulating a desired bin of an inventory holder for item stowing.

The process 800 may continue by stowing the item to the desired bin, as at 816. For example, the robotic arm and end effector may move and position the item in the desired bin, and then release the item into the bin to complete stowing. In addition, any manipulation of the desired bin to facilitate stowing may be stopped or discontinued, such that the stowed item is retained within the bin. Further, a control system may instruct stowing the item to the desired bin.

The process 800 may then end, as at 818. Furthermore, the various steps of FIG. 8 may be repeated to perform additional retrieval of items from a buffer wall.

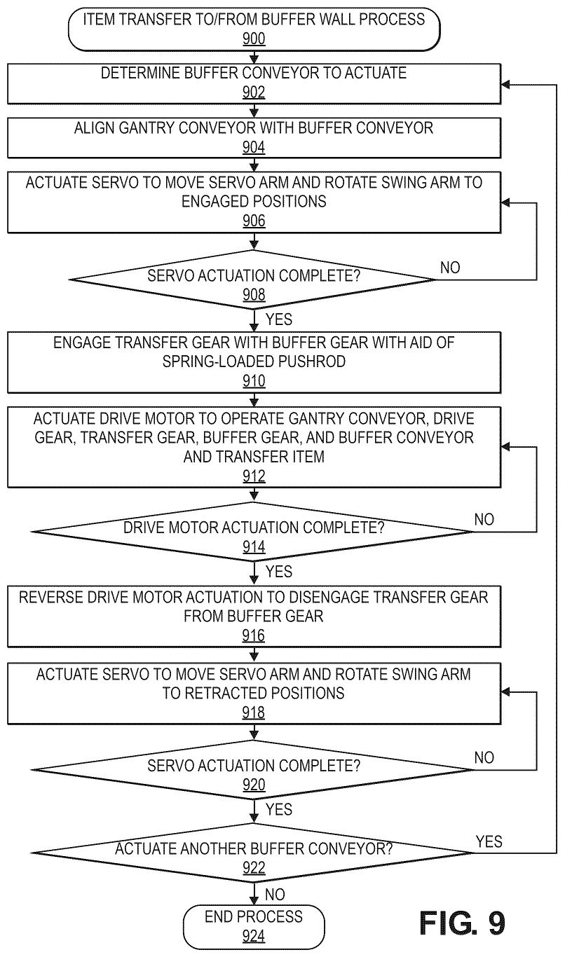

FIG. 9 is a flow diagram illustrating an example item transfer to/from buffer wall process 900, in accordance with implementations of the present disclosure.

The process 900 may begin by determining a buffer conveyor to actuate, as at 902. For example, as described herein at least with respect to FIGS. 7, 8, and 10, a shelf or cubby may be selected or determined for storage or retrieval of an item, and the shelf or cubby may have an associated buffer conveyor. In addition, the shelf or cubby and associated buffer conveyor may have an associated identifier, e.g., stored in a database or memory, that indicates a position of the buffer conveyor within a buffer wall. Further, a control system may instruct determining a buffer conveyor to actuate.

The process 900 may continue by aligning a gantry conveyor with the buffer conveyor, as at 904. For example, based on a determined position of the buffer conveyor within a buffer wall, the gantry system may be instructed to move the gantry conveyor, e.g., a gantry infeed conveyor or gantry outfeed conveyor, to the buffer conveyor. In addition, the gantry system may align the gantry conveyor with a front face of the shelf or cubby, and further align a conveyor belt of the gantry conveyor with a conveyor belt of the buffer conveyor. Further, a control system may instruct aligning the gantry conveyor with the buffer conveyor.

The process 900 may proceed by actuating a servo to move a servo arm and rotate a swing arm to engaged positions, as at 906. For example, a power transmission mechanism of the gantry conveyor may be actuated to engage with and transfer power to the buffer conveyor. As described herein, a servo motor may be actuated to move a servo arm, a pushrod, and a swing arm to respective engaged positions, in order to transfer power from the gantry conveyor to the buffer conveyor. Further, a control system may instruct actuating a servo motor to move a servo arm and swing arm to respective engaged positions.

The process 900 may continue to determine whether servo actuation is complete, as at 908. For example, the servo motor may be actuated to move or rotate to an engaged position, e.g., from a retracted position. In some examples, the servo motor may comprise an encoder that detects or measures a rotational position and/or rotation of a servo shaft of the servo motor. The servo motor may be instructed to actuate to an engaged position based on data from the encoder, and completion of actuation of the servo motor to the engaged position may be determined based on data from the encoder. Further, a control system may instruct determining whether servo actuation is complete. If it is determined that servo actuation is not yet complete, the process 900 may return to step 906 and continue to actuate the servo motor.

If, however, it is determined that servo actuation is complete, the process 900 may proceed to engage a transfer gear with a buffer gear with aid of a spring-loaded pushrod, as at 910. For example, during actuation of the power transmission mechanism to engage with the buffer conveyor, moving the swing arm to the engaged position may cause movement of the transfer gear into engagement with a buffer gear of the buffer conveyor. In addition, the spring-loaded pushrod of the power transmission mechanism may aid in overcoming gear teeth collisions and facilitating proper engagement between the transfer gear and the buffer gear, in order to transfer power to the buffer conveyor. Further, a control system may instruct engaging the transfer gear with the buffer gear with aid of the spring-loaded pushrod.

The process 900 may then continue with actuating a drive motor to operate the gantry conveyor, a drive gear, the transfer gear, the buffer gear, and the buffer conveyor and transfer an item, as at 912. For example, the drive motor of the gantry conveyor may be actuated to rotate a drive shaft, in order to cause movement of a conveyor belt of the gantry conveyor, e.g., either in an infeed or outfeed direction. The drive gear may be coupled to and rotate together with the drive shaft, and with the swing arm in the engaged position, the rotation of the drive gear may cause corresponding rotation of the transfer gear and buffer gear via engagement of their respective gear teeth. In addition, the buffer gear may be coupled to and rotate together with a buffer shaft that then causes movement of a conveyor belt of the buffer conveyor, e.g., in a same direction as the conveyor belt of the gantry conveyor. As a result, an item may be transferred between the gantry conveyor and the buffer conveyor. Moreover, the engagement between the drive gear, transfer gear, and buffer gear may be substantially self-engaging based on their reaction forces during actuation, as further described herein. Further, a control system may instruct actuating the drive motor to operate the gantry conveyor and buffer conveyor to transfer an item therebetween.

The process 900 may proceed with determining whether drive motor actuation is complete, as at 914. For example, the drive motor may be actuated to cause movement of a conveyor belt of the gantry conveyor, and also to cause movement of a conveyor belt of the buffer conveyor via the power transmission mechanism, thereby transferring an item therebetween. In some examples, the drive motor may comprise an encoder that detects or measures a rotational position and/or rotation of the drive shaft of the drive motor. The drive motor may be instructed to actuate to move the conveyor belt of the gantry conveyor based on data from the encoder, and completion of actuation of the drive motor to move the conveyor belt of the gantry conveyor may be determined based on data from the encoder. Further, a control system may instruct determining whether drive motor actuation is complete. If it is determined that drive motor actuation is not yet complete, the process 900 may return to step 912 and continue to actuate the drive motor.

If, however, it is determined that drive motor actuation is complete, the process 900 may continue by reversing the drive motor actuation to disengage the transfer gear from the buffer gear, as at 916. For example, because the drive gear, transfer gear, and buffer gear may be substantially self-engaging based on their reaction forces during actuation, actuation of the drive motor may be reversed in order to cause disengagement between the transfer gear and the buffer gear. The reverse actuation of the drive motor may comprise a relatively short rotational distance, e.g., corresponding to approximately 20 mm of movement of the conveyor belt. Further, a control system may instruct reversing the drive motor actuation to disengage the transfer gear from the buffer gear.

The process 900 may proceed by actuating the servo to move the servo arm and rotate the swing arm to retracted positions, as at 918. For example, the power transmission mechanism of the gantry conveyor may be actuated to disengage from and stop transferring power to the buffer conveyor. As described herein, a servo motor may be actuated to move a servo arm, a pushrod, and a swing arm to respective retracted positions, in order to stop transferring power from the gantry conveyor to the buffer conveyor. Further, a control system may instruct actuating the servo motor to move the servo arm and swing arm to respective retracted positions.

The process 900 may continue to determine whether servo actuation is complete, as at 920. For example, the servo motor may be actuated to move or rotate to a retracted position, e.g., from an engaged position. In some examples, the servo motor may comprise an encoder that detects or measures a rotational position and/or rotation of a servo shaft of the servo motor. The servo motor may be instructed to actuate to a retracted position based on data from the encoder, and completion of actuation of the servo motor to the retracted position may be determined based on data from the encoder. Further, a control system may instruct determining whether servo actuation is complete. If it is determined that servo actuation is not yet complete, the process 900 may return to step 918 and continue to actuate the servo motor.

If, however, it is determined that servo actuation is complete, the process 900 may proceed to determine whether to actuate another buffer conveyor, as at 922. For example, one or more additional items may be identified or determined for storage or removal with respect to individual shelves or cubbies of a buffer wall. Then, it may be determined that another buffer conveyor is to be actuated to transfer one or more items for storage or retrieval with respect to the buffer wall. Further, a control system may instruct determining whether to actuate another buffer conveyor. If it is determined that another buffer conveyor is to be actuated, the process 900 may return to step 902 and repeat the steps described herein.

If, however, it is determined that another buffer conveyor is not to be actuated, the process 900 may then end, as at 924. Furthermore, the various steps of FIG. 9 may be repeated to perform additional transfers of items to and from a buffer wall.

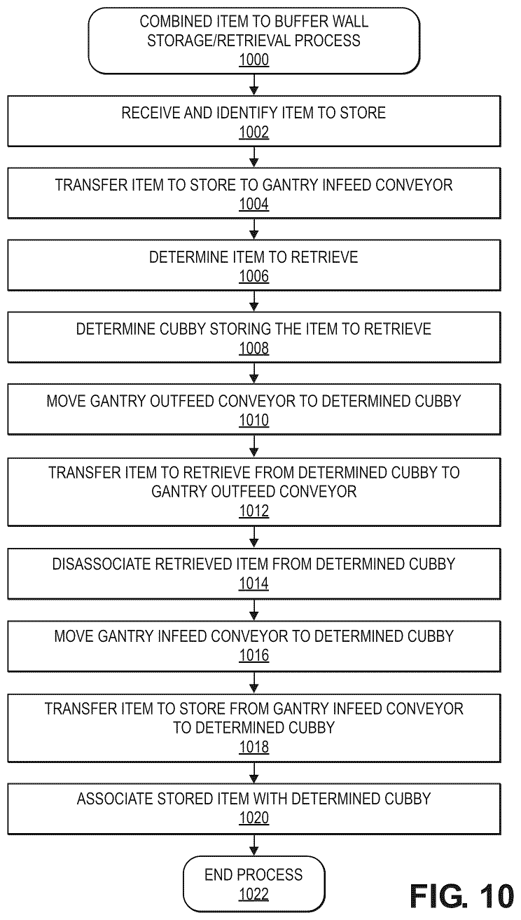

FIG. 10 is a flow diagram illustrating an example combined item to buffer wall storage/retrieval process 1000, in accordance with implementations of the present disclosure.

The process 1000 may begin by receiving and identifying an item to store, as at 1002. For example, an item may be received from a source outside a material handling facility, or a different system or process within a material handling facility. In addition, the item may be identified using various methods, e.g., based on imaging data, by scanning identifiers associated with the item, by detecting radiofrequency identifiers, and/or other methods. Further, a control system may instruct receiving and identifying the item for storage.

The process 1000 may continue by transferring the item to store to a gantry infeed conveyor, as at 1004. For example, the item may be moved or transferred to the gantry infeed conveyor via various methods, such as robotic or automated vehicles or shuttles, robotic arms and end effectors, conveyors, slides, chutes, and/or other methods. Then, the gantry infeed conveyor may receive the item on an upper surface of a conveyor belt thereof. Further, a control system may instruct transferring the item to the gantry infeed conveyor.

The process 1000 may proceed by determining an item to retrieve, as at 1006. For example, it may be determined to retrieve an item that has previously been stored in a cubby of a buffer wall. For example, the item may be requested by a downstream system or process, e.g., for packaging and shipping to a destination. In addition, an identifier associated with the item may be determined. Further, a control system may instruct determining an item to retrieve.

The process 1000 may continue to determine a cubby storing the item to retrieve, as at 1008. For example, based on a stored association between the identifier of the item and a cubby of the buffer wall, it may be determined that the item was previously stored in a particular shelf or cubby of the buffer wall. In addition, a location or position of the determined cubby within the buffer wall may be identified. Further, a control system may instruct determining a cubby storing the item to retrieve.

The process 1000 may proceed to move the gantry outfeed conveyor to the determined cubby, as at 1010. For example, the gantry system may comprise one or more vertical and/or horizontal movement mechanisms to cause movement of a gantry outfeed conveyor to a desired position. In this manner, the gantry outfeed conveyor may be positioned or aligned with the determined cubby, e.g., aligned to a front face of the cubby so that a conveyor belt of the gantry outfeed conveyor is approximately coplanar with a conveyor belt of the determined cubby. Further, a control system may instruct moving the gantry outfeed conveyor to the determined cubby.

The process 1000 may continue with transferring the item to retrieve from the determined cubby to the gantry outfeed conveyor, as at 1012. For example, the gantry outfeed conveyor may actuate a conveyor belt to cause movement of the item out of the determined cubby. In addition, a conveyor belt of the selected cubby, e.g., a buffer conveyor, may also be actuated to transfer the item out of the determined cubby to the gantry outfeed conveyor. In some examples, the buffer conveyor may comprise an active conveyor unit that includes an actuator to cause movement of the conveyor belt, and in other examples, the buffer conveyor may comprise a passive conveyor unit that is actuated by the gantry outfeed conveyor via a power transmission mechanism. Further, a control system may instruct transferring the item to the gantry outfeed conveyor.

The process 1000 may proceed with disassociating the retrieved item from the determined cubby, as at 1014. For example, upon transferring the item out of the determined cubby, identifiers of the retrieved item and the determined cubby may be disassociated from each other in a database or memory. In this manner, a removal of the item from the determined cubby of the buffer wall may be updated and confirmed, in order to maintain accurate data related to items stored within the buffer wall for subsequent processing. Further, a control system may instruct disassociating the retrieved item from the determined cubby.

The process 1000 may then continue by moving the gantry infeed conveyor to the determined cubby, as at 1016. For example, the gantry system may comprise one or more vertical and/or horizontal movement mechanisms to cause movement of the gantry infeed conveyor to a desired position. In this manner, the gantry infeed conveyor may be positioned or aligned with the determined cubby, e.g., aligned to a front face of the cubby so that a conveyor belt of the gantry infeed conveyor is approximately coplanar with a conveyor belt of the selected cubby. Moreover, the gantry infeed conveyor may be aligned with the determined cubby from which an item was just retrieved using the gantry outfeed conveyor. Further, a control system may instruct moving the gantry infeed conveyor to the determined cubby.

The process 1000 may proceed by transferring the item to store from the gantry infeed conveyor to the determined cubby, as at 1018. For example, the gantry infeed conveyor may actuate a conveyor belt to cause movement of the item to store toward the determined cubby. In addition, a conveyor belt of the determined cubby, e.g., a buffer conveyor, may also be actuated to receive the item from the gantry infeed conveyor into the selected cubby. In some examples, the buffer conveyor may comprise an active conveyor unit that includes an actuator to cause movement of the conveyor belt, and in other examples, the buffer conveyor may comprise a passive conveyor unit that is actuated by the gantry infeed conveyor via a power transmission mechanism. Further, a control system may instruct transferring the item to store to the determined cubby.

The process 1000 may continue to associate the stored item with the determined cubby, as at 1020. For example, identifiers of the stored item and of the determined cubby may be associated with each other and stored in a database or memory. In this manner, a position of the stored item within the determined cubby of the buffer wall may be known and maintained, in order to facilitate later retrieval of the item for subsequent processing. Further, a control system may instruct associating the stored item with the determined cubby.

The process 1000 may then end, as at 1022.

Although not illustrated in FIG. 10, various other steps or processes may be performed during or subsequent to the described steps, including reorienting, grasping, transferring, and/or stowing the retrieved item to a bin of an inventory holder or to a downstream process or system. Furthermore, the various steps of FIG. 10 may be repeated to perform additional storage and/or retrieval of items relative to a buffer wall.

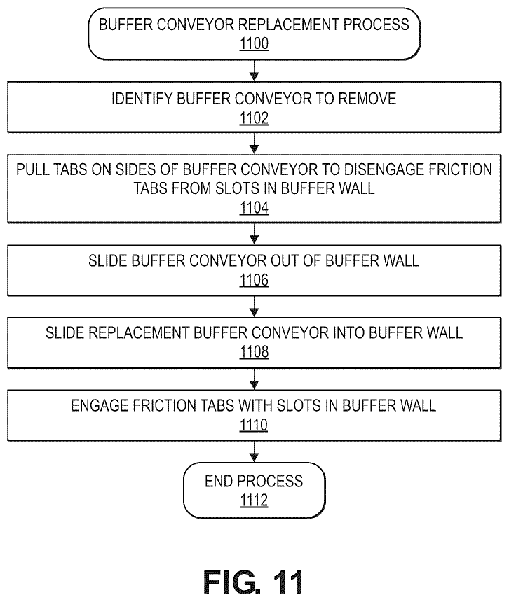

FIG. 11 is a flow diagram illustrating an example buffer conveyor replacement process 1100, in accordance with implementations of the present disclosure.

The process 1100 may begin by identifying a buffer conveyor to remove, as at 1102. For example, one or more buffer conveyors of a buffer wall may need to be removed for repair, cleaning, service, replacement, disassembly, and/or other reasons. In addition, individual buffer conveyors may be associated with respective identifiers and additional data stored in a database or memory, and positions or locations of individual buffer conveyors within a buffer wall may be determined based on such data. Moreover, removal and replacement of a buffer conveyor may be performed manually, or in at least partially automated manner using robotic arms, end effectors, gantry systems, or other automated or robotic devices. Further, a control system may instruct identifying a buffer conveyor to remove or replace.

The process 1100 may continue by pulling tabs on sides of the buffer conveyor to disengage friction tabs from slots in the buffer wall, as at 1104. For example, as described herein, pull tabs or strips with friction engagement features may be associated with sides of individual buffer conveyors. In addition, tracks with corresponding friction engagement features may be associated with sidewalls of the buffer wall to receive individual buffer conveyors. By pulling on the pull tabs, friction engagement features or tabs associated with the buffer conveyor may be released or disengaged from friction engagement features or slots of the sidewalls, thereby allowing removal of the buffer conveyor for the buffer wall. Further, a control system may instruct pulling the tabs on sides of the buffer conveyor to release from the buffer wall.

The process 1100 may proceed by sliding the buffer conveyor out of the buffer wall, as at 1106. For example, after releasing or disengaging friction engagement features between the buffer conveyor and sidewalls of the buffer wall, the buffer conveyor may be removed or slid out of the buffer wall, e.g., along tracks associated with sidewalls of the buffer wall. Further, a control system may instruct sliding the buffer conveyor out of the buffer wall.

The process 1100 may continue to slide a replacement buffer conveyor into the buffer wall, as at 1108. For example, a new or replacement buffer conveyor may be inserted or installed into the empty shelf or cubby from which the prior buffer conveyor was removed. The friction engagement features of the replacement buffer conveyor may be inserted or engaged with tracks of the sidewalls of the buffer wall, in order to install or assemble the replacement buffer conveyor into the buffer wall. Further, a control system may instruct sliding a replacement buffer conveyor into the buffer wall.

The process 1100 may proceed to engage friction tabs with slots in the buffer wall, as at 1110. For example, upon complete or approximately complete insertion of the replacement buffer conveyor into the shelf or cubby of the buffer wall, the friction engagement features or tabs associated with the buffer conveyor may engage with friction engagement features or slots of the sidewalls, thereby securing and retaining the replacement buffer conveyor within the buffer wall. Further, a control system may instruct engaging friction tabs with slots in the buffer wall.

The process 1100 may then end, as at 1112. Furthermore, the various steps of FIG. 11 may be repeated to perform additional removal and/or replacement of buffer conveyors relative to a buffer wall.

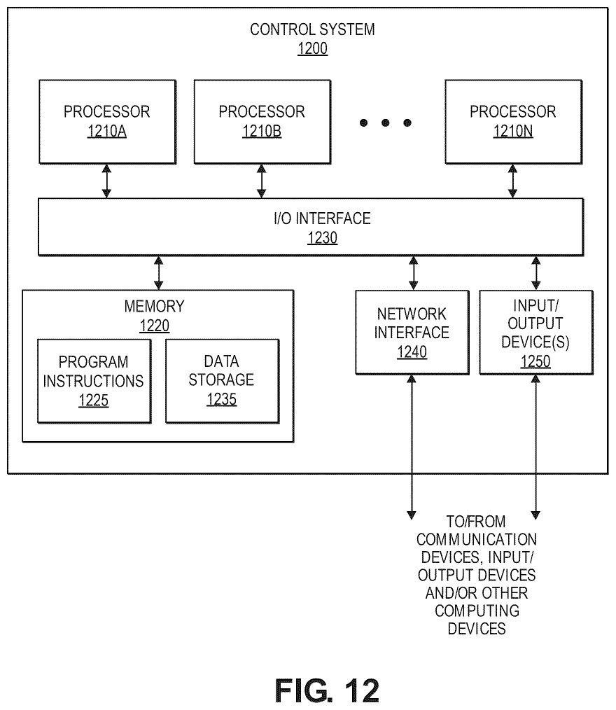

FIG. 12 is a block diagram illustrating various components of an example control system 1200, in accordance with implementations of the present disclosure.

Various operations of a control system or controller, such as those described herein, may be executed on one or more computer systems, and/or interacting with various other computers, systems, or devices in a material handling facility, according to various implementations. For example, the control system or controller discussed above may function and operate on one or more computer systems. In the illustrated implementation, a control system 1200 includes one or more processors 1210A, 1210B through 1210N, coupled to a non-transitory computer-readable storage medium 1220 via an input/output (I/O) interface 1230. The control system 1200 further includes a network interface 1240 coupled to the I/O interface 1230, and one or more input/output devices 1250. In some implementations, it is contemplated that a described implementation may be implemented using a single instance of the control system 1200 while, in other implementations, multiple such systems or multiple nodes making up the control system 1200 may be configured to host different portions or instances of the described implementations. For example, in one implementation, some data sources or services (e.g., related to portions of buffer wall systems, operations, or processes, etc.) may be implemented via one or more nodes of the control system 1200 that are distinct from those nodes implementing other data sources or services (e.g., related to other portions of buffer wall systems, operations, or processes, etc.).

In various implementations, the control system 1200 may be a uniprocessor system including one processor 1210A, or a multiprocessor system including several processors 1210A-1210N (e.g., two, four, eight, or another suitable number). The processors 1210A-1210N may be any suitable processor capable of executing instructions. For example, in various implementations, the processors 1210A-1210N may be general-purpose or embedded processors implementing any of a variety of instruction set architectures (ISAs), such as the x86, PowerPC, SPARC, or MIPS ISAs, or any other suitable ISA. In multiprocessor systems, each of the processors 1210A-1210N may commonly, but not necessarily, implement the same ISA.

The non-transitory computer-readable storage medium 1220 may be configured to store executable instructions and/or data accessible by the one or more processors 1210A-1210N. In various implementations, the non-transitory computer-readable storage medium 1220 may be implemented using any suitable memory technology, such as static random access memory (SRAM), synchronous dynamic RAM (SDRAM), nonvolatile/Flash-type memory, or any other type of memory. In the illustrated implementation, program instructions and data implementing desired functions and/or processes, such as those described above, are shown stored within the non-transitory computer-readable storage medium 1220 as program instructions 1225 and data storage 1235, respectively. In other implementations, program instructions and/or data may be received, sent or stored upon different types of computer-accessible media, such as non-transitory media, or on similar media separate from the non-transitory computer-readable storage medium 1220 or the control system 1200. Generally speaking, a non-transitory, computer-readable storage medium may include storage media or memory media such as magnetic or optical media, e.g., disk or CD/DVD-ROM, coupled to the control system 1200 via the I/O interface 1230. Program instructions and data stored via a non-transitory computer-readable medium may be transmitted by transmission media or signals such as electrical, electromagnetic, or digital signals, which may be conveyed via a communication medium such as a network and/or a wireless link, such as may be implemented via the network interface 1240.

In one implementation, the I/O interface 1230 may be configured to coordinate I/O traffic between the processors 1210A-1210N, the non-transitory computer-readable storage medium 1220, and any peripheral devices, including the network interface 1240 or other peripheral interfaces, such as input/output devices 1250. In some implementations, the I/O interface 1230 may perform any necessary protocol, timing or other data transformations to convert data signals from one component (e.g., non-transitory computer-readable storage medium 1220) into a format suitable for use by another component (e.g., processors 1210A-1210N). In some implementations, the I/O interface 1230 may include support for devices attached through various types of peripheral buses, such as a variant of the Peripheral Component Interconnect (PCI) bus standard or the Universal Serial Bus (USB) standard, for example. In some implementations, the function of the I/O interface 1230 may be split into two or more separate components, such as a north bridge and a south bridge, for example. Also, in some implementations, some or all of the functionality of the I/O interface 1230, such as an interface to the non-transitory computer-readable storage medium 1220, may be incorporated directly into the processors 1210A-1210N.

The network interface 1240 may be configured to allow data to be exchanged between the control system 1200 and other devices attached to a network, such as other control systems, material handling system controllers, warehouse management systems, other computer systems, robotic arms, machines, or systems, conveyance systems or devices, various types of sensors, various types of vision systems, imaging devices, scanning devices, or imaging sensors, upstream stations or processes, downstream stations or processes, other material handling systems or equipment, or between nodes of the control system 1200. In various implementations, the network interface 1240 may support communication via wired or wireless general data networks, such as any suitable type of Ethernet network.

Input/output devices 1250 may, in some implementations, include one or more displays, monitors, screens, projection devices, touchscreens, imaging devices, scanning devices, other visual input/output devices, speakers, microphones, other audio input/output devices, keyboards, keypads, touchpads, sensors, photo eyes, proximity sensors, RFID readers, voice or optical recognition devices, or any other devices suitable for entering or retrieving data by one or more control systems 1200. Multiple input/output devices 1250 may be present in the control system 1200 or may be distributed on various nodes of the control system 1200. In some implementations, similar input/output devices may be separate from the control system 1200 and may interact with one or more nodes of the control system 1200 through a wired or wireless connection, such as over the network interface 1240.

As shown in FIG. 12, the memory 1220 may include program instructions 1225 that may be configured to implement one or more of the described implementations and/or provide data storage 1235, which may comprise various tables, data stores and/or other data structures accessible by the program instructions 1225. The program instructions 1225 may include various executable instructions, programs, or applications to facilitate buffer wall operations and processes described herein, such as gantry system controllers, drivers, or applications, robotic arm and end effector controllers, drivers, or applications, item or bin manipulation device controllers, drivers, or applications, drive motor controllers, drivers, or applications, servo motor controllers, drivers, or applications, other actuator controllers, drivers, or applications, sensor controllers, drivers, or applications, sensor data processing applications, vision system, imaging device, or scanning device controllers, drivers, or applications, imaging data processing applications, material handling equipment controllers, drivers, or applications, upstream station controllers, drivers, or applications, downstream station controllers, drivers, or applications, etc. The data storage 1235 may include various data stores for maintaining data related to systems, operations, or processes described herein, such as buffer walls, shelves or cubbies, robotic arms and end effectors, gantry systems, gantry conveyors, gantry conveyor belts, drive motors, power transmission mechanisms, servo motors, servo arms, pushrods, swing arms, drive gears, transfer gears, retracted positions, engaged positions, buffer conveyors, pull tabs, tracks, friction engagement features, buffer gears, buffer conveyor belts, actuators, sensors, sensor data, vision systems, imaging devices, or scanning devices, imaging data, items or objects, bins, inventory holders, material handling equipment or apparatus, upstream systems, stations, or processes, downstream systems, stations, or processes, etc.

Those skilled in the art will appreciate that the control system 1200 is merely illustrative and is not intended to limit the scope of implementations. In particular, the control system and devices may include any combination of hardware or software that can perform the indicated functions, including other control systems or controllers, computers, network devices, internet appliances, robotic devices, etc. The control system 1200 may also be connected to other devices that are not illustrated, or instead may operate as a stand-alone system. In addition, the functionality provided by the illustrated components may, in some implementations, be combined in fewer components or distributed in additional components. Similarly, in some implementations, the functionality of some of the illustrated components may not be provided and/or other additional functionality may be available.

It should be understood that, unless otherwise explicitly or implicitly indicated herein, any of the features, characteristics, alternatives or modifications described regarding a particular implementation herein may also be applied, used, or incorporated with any other implementation described herein, and that the drawings and detailed description of the present disclosure are intended to cover all modifications, equivalents and alternatives to the various implementations as defined by the appended claims. Moreover, with respect to the one or more methods or processes of the present disclosure described herein, including but not limited to the flow charts shown in FIGS. 7-11, orders in which such methods or processes are presented are not intended to be construed as any limitation on the claimed inventions, and any number of the method or process steps or boxes described herein can be omitted, reordered, or combined in any order and/or in parallel to implement the methods or processes described herein. Also, the drawings herein are not drawn to scale.

Conditional language, such as, among others, “can,” “could,” “might,” or “may,” unless specifically stated otherwise, or otherwise understood within the context as used, is generally intended to convey in a permissive manner that certain implementations could include, or have the potential to include, but do not mandate or require, certain features, elements and/or steps. In a similar manner, terms such as “include,” “including” and “includes” are generally intended to mean “including, but not limited to.” Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

The elements of a method, process, or algorithm described in connection with the implementations disclosed herein can be embodied directly in hardware, in a software module stored in one or more memory devices and executed by one or more processors, or in a combination of the two. A software module can reside in RAM, flash memory, ROM, EPROM, EEPROM, registers, a hard disk, a removable disk, a CD ROM, a DVD-ROM or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC. The ASIC can reside in a user terminal. In the alternative, the processor and the storage medium can reside as discrete components in a user terminal.

Disjunctive language such as the phrase “at least one of X, Y, or Z,” or “at least one of X, Y and Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain implementations require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Language of degree used herein, such as the terms “about,” “approximately,” “generally,” “nearly” or “substantially” as used herein, represent a value, amount, or characteristic close to the stated value, amount, or characteristic that still performs a desired function or achieves a desired result. For example, the terms “about,” “approximately,” “generally,” “nearly” or “substantially” may refer to an amount that is within less than 10% of, within less than 5% of, within less than 1% of, within less than 0.1% of, and within less than 0.01% of the stated amount.

Although the invention has been described and illustrated with respect to illustrative implementations thereof, the foregoing and various other additions and omissions may be made therein and thereto without departing from the spirit and scope of the present disclosure.

What is claimed is:

1. A buffer wall system, comprising:
a frame;
a plurality of passive buffer conveyors arranged as shelves within the frame;
a gantry system configured to move among the plurality of passive buffer conveyors;
a gantry infeed conveyor and a gantry outfeed conveyor associated with the gantry system, the gantry infeed conveyor and the gantry outfeed conveyor configured to selectively engage with and transfer power to individual passive buffer conveyors of the plurality of passive buffer conveyors via respective power transmission mechanisms; and
a controller configured to at least:
instruct movement of the gantry system to align one of the gantry infeed conveyor or the gantry outfeed conveyor with a selected passive buffer conveyor;
cause engagement, via a respective power transmission mechanism, between the one of the gantry infeed conveyor or the gantry outfeed conveyor and the selected passive buffer conveyor; and
cause transfer of an item between the one of the gantry infeed conveyor or the gantry outfeed conveyor and the selected passive buffer conveyor.

2. The buffer wall system of claim 1, wherein the item is transferred from the gantry infeed conveyor to the selected passive buffer conveyor; and
wherein the controller is further configured to:
associate the item with the selected passive buffer conveyor.

3. The buffer wall system of claim 1, wherein the item is transferred from the selected passive buffer conveyor to the gantry outfeed conveyor; and
wherein the controller is further configured to:
disassociate the item from the selected passive buffer conveyor.

4. The buffer wall system of claim 1, wherein each of the gantry infeed conveyor and the gantry outfeed conveyor comprises a respective drive motor that is operatively coupled to the respective power transmission mechanism; and
wherein the selected passive buffer conveyor is driven by the respective drive motor via engagement with the respective power transmission mechanism.

5. The buffer wall system of claim 1, wherein individual ones of the plurality of passive buffer conveyors comprise modular buffer conveyors having friction fit engagement with respective sidewalls of the frame.

6. A system, comprising:
a buffer conveyor; and
at least one powered conveyor configured to selectively transfer power to the buffer conveyor via a power transmission mechanism that moves between an engaged configuration and a retracted configuration.

7. The system of claim 6, further comprising:
a movement system configured to selectively align the at least one powered conveyor with the buffer conveyor;
wherein the movement system comprises at least one of a gantry system or a robotic arm.

8. The system of claim 7, wherein the buffer conveyor comprises one of a plurality of buffer conveyors arranged as shelves within a frame;
wherein the at least one powered conveyor is configured to selectively transfer power to individual ones of the plurality of buffer conveyors via the power transmission mechanism; and
wherein the movement system is configured to selectively align the at least one powered conveyor with individual ones of the plurality of buffer conveyors.

9. The system of claim 6, wherein the at least one powered conveyor further comprises:
a drive motor and a drive shaft configured to cause movement of a conveyor belt associated with the at least one powered conveyor;
wherein the power transmission mechanism is configured to transfer power from the drive motor to the buffer conveyor; and
wherein the buffer conveyor further comprises:
a buffer shaft configured to receive power from the drive motor via the power transmission mechanism, thereby causing movement of a conveyor belt associated with the buffer conveyor.

10. The system of claim 9, wherein the power transmission mechanism is configured to cause the conveyor belt associated with the at least one powered conveyor and the conveyor belt associated with the buffer conveyor to move in a same direction.

11. The system of claim 9, wherein the power transmission mechanism further comprises:
a swing arm rotatably coupled to the drive shaft of the drive motor; and
a transfer gear associated with the swing arm, and operatively coupled to a drive gear of the drive shaft.

12. The system of claim 11, wherein in a retracted position of the swing arm, the transfer gear is disengaged from a buffer gear coupled to the buffer shaft of the buffer conveyor; and
wherein in an engaged position of the swing arm, the transfer gear is engaged with the buffer gear coupled to the buffer shaft of the buffer conveyor.

13. The system of claim 12, wherein in the engaged position, reaction forces among the drive gear, the transfer gear, and the buffer gear bias the transfer gear and the swing arm toward the engaged position.

14. The system of claim 12, wherein the power transmission mechanism further comprises:
a servo arm that is moved between two positions by a servo motor; and
a pushrod that is operatively connected between the servo arm and the swing arm;
wherein movement of the servo arm between the two positions causes corresponding movement of the swing arm via the pushrod between the retracted position and the engaged position.

15. The system of claim 14, wherein the pushrod comprises a bias element to facilitate engagement between teeth of the transfer gear and teeth of the buffer gear.

16. The system of claim 7, further comprising:
a controller configured to at least:
instruct the movement system to align the at least one powered conveyor with the buffer conveyor;
cause, via the power transmission mechanism, engagement between the at least one powered conveyor and the buffer conveyor; and
cause transfer of an item between the at least one powered conveyor and the buffer conveyor.

17. A method, comprising:
determining, by a controller, to transfer an item between at least one powered conveyor and a buffer conveyor;
causing, by the controller, actuation of a power transmission mechanism of the at least one powered conveyor from a retracted configuration to an engaged configuration to transfer power from the at least one powered conveyor to the buffer conveyor; and
causing, by the controller via the power transmission mechanism, transfer of the item between the at least one powered conveyor and the buffer conveyor.

18. The method of claim 17, wherein causing actuation of the power transmission mechanism further comprises:
causing, by the controller, actuation of the power transmission mechanism to transfer power from a drive motor and a drive shaft of the at least one powered conveyor to a buffer shaft of the buffer conveyor.

19. The method of claim 18, wherein causing actuation of the power transmission mechanism further comprises:
causing, by the controller via a servo motor, movement of a servo arm and a swing arm to respective engaged positions, thereby causing engagement among a drive gear of the drive shaft, a transfer gear of the swing arm, and a buffer gear of the buffer shaft.

20. The method of claim 19, wherein the drive motor and the drive shaft cause movement of a conveyor belt associated with the at least one powered conveyor in a first direction; and
wherein engagement among the drive gear, the transfer gear, and the buffer gear causes corresponding movement of a conveyor belt associated with the buffer conveyor in the first direction.
